(19) United States
(12) Patent Application Publication
(10) Pub. No.: US 2002/0053192 A1
(43) Pub. Date: May 9, 2002

(54) Vacuum-cleaner bags

(75) Inventor: Jose Ma Paris Ibos, Sabadell (ES)

Correspondence Address: DARBY & DARBY P.C., 805 Third Avenue, New York, NY, 10022, US

(73) Assignee: CELIM, S.A.

(21) Appl. No.: 10/021,476

(22) Filed: Oct. 30, 2001

(30) Foreign Application Priority Data
Nov. 3, 2000 (ES) 200002650

(51) Int. Cl. B01D 46/02

(52) U.S. Cl. 55/374

(57) ABSTRACT

The improvements apply to a textile bag element which is permeable to air but not to dust, with a mouth in which the fixed portion of the vacuum-cleaner can be coupled by means of an adhesive connection, characterized by the arrangement of an element in the form of a flexible and adaptable flat disk fixed permanently in the mouth of the bag and having a hook-and-loop fastening element on its outer face, a second element also being provided in the form of a flat disk which is of similar shape to the first, is provided with a complementary hook-and-loop fastening element on its opposite face, and can be fitted removably on the disk fixed in the bag, the second element having, on its outer face, an adhesive region to which a protective disk is applied.

### DESCRIPTION

The present invention is intended to disclose some improvements in vacuum-cleaner bags which provide considerable characteristics of novelty and of inventive activity.

Currently, there are many known kinds of vacuum-cleaner bags which, in general, are of two types: the first type comprises bags made of disposable cellulose materials and the second type comprises bags which are made of various materials, for example, textile materials and permeable materials, and which have, at their mouths, substantially rigid coupling regions that can be used several times. In one particular case, the region surrounding the mouth has stiffness characteristics in order to act as reinforcement.

The aim of the present invention is to permit the production of vacuum-cleaner bags in which notable characteristics of flexibility and adaptability are achieved in all of the parts of the bag, both in the body of the bag and in the region to be fitted on the vacuum-cleaner mouth, and which are washable and permit protracted reuse, thus achieving more effective and economical characteristics of use than in currently known bags.

To achieve its aims, the present invention provides for the vacuum-cleaner bag to be formed by a bag which is made of a washable textile material of a type conventional in the field, and which has one end provided with a flexible annular coupling that in practice does not increase the stiffness of the bag, the bag having, at the opposite end, a repeatedly reusable slide fastener for quick opening and closure. The mouth to be fitted on the vacuum-cleaner comprises a substantially annular textile body with characteristics of flexibility and adaptability similar to those of the bag itself, that is, without stiffness, this body being fixed permanently to the bag by one of its faces and having, on its other face, a fastening of the so-called projection-and-hook or hook-and-loop type, for example, the system known commercially by the trade mark “Velcro”, the annular body being complemented by a second annular element which can be fitted over the first and which has the complementary portion of the hook-and-loop fastening on its face in opposition to the first annular body, said second annular element having, on its outer face, a layer of adhesive protected by a detachable annular protection element.

By virtue of the above-mentioned arrangement, the vacuum-cleaner bag of the present invention can be fitted and removed easily and can be washed an indefinite number of times, and its use is also greatly simplified with regard to its opening and closure in order to remove its contents.

For a better understanding, some drawings which show the application of the improvements of the present invention to a vacuum-cleaner bag are appended by way of non-limiting example.

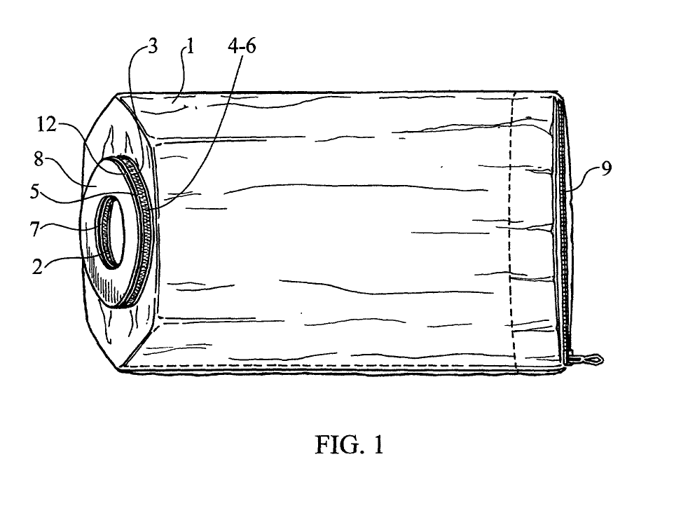

FIG. 1 is a perspective view of a vacuum-cleaner bag which incorporates the improvements of the invention.

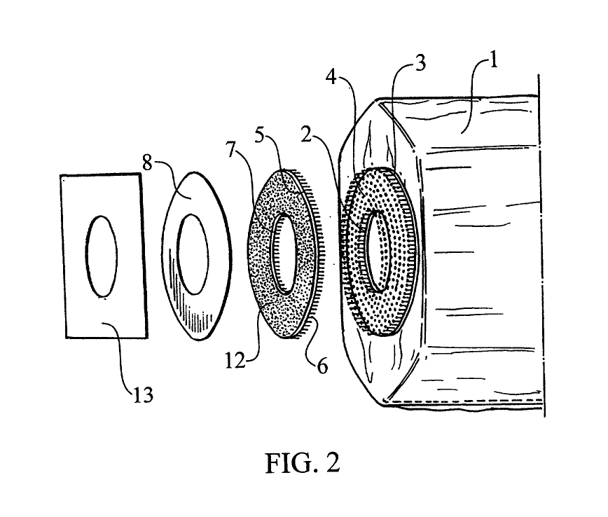

FIG. 2 is a perspective view of the front portion of the bag of FIG. 1 with parts disassembled.

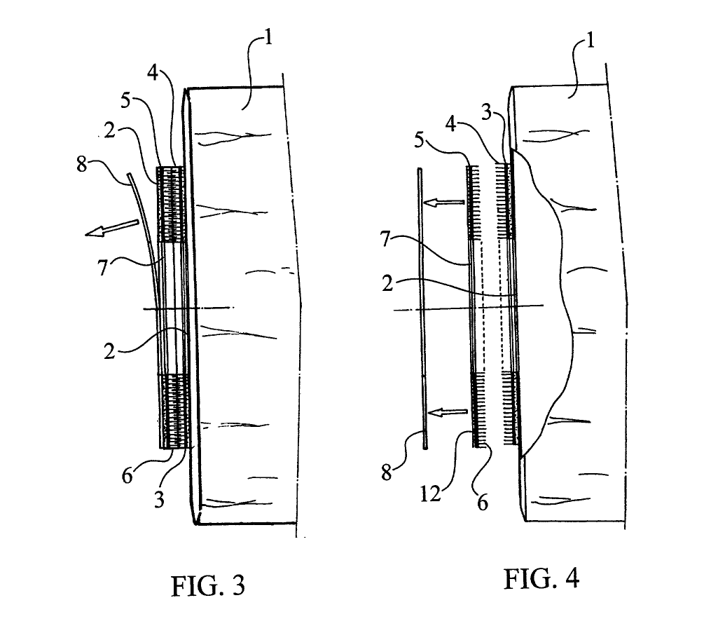

FIGS. 3 and 4 show respective cross-sections of the mouth of the bag in the assembled and disassembled conditions, respectively.

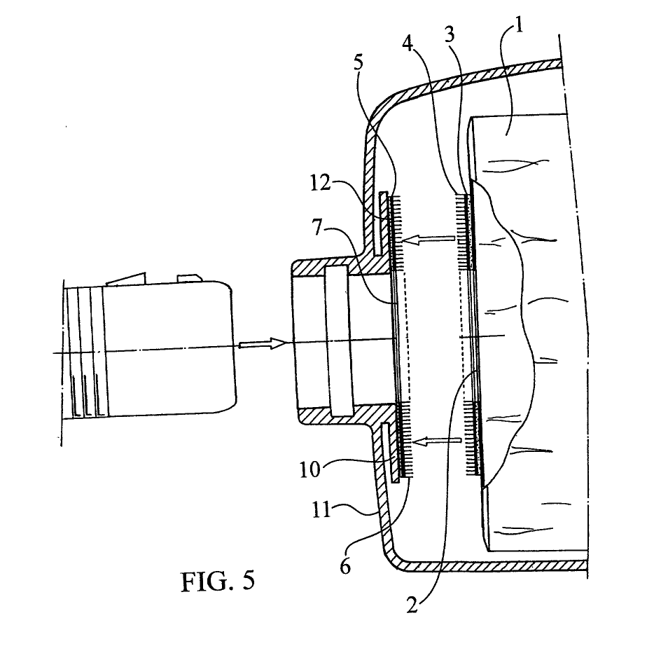

FIG. 5 shows schematically the arrangement of the bag inside a collector corresponding to the vacuum cleaner of the desired type.

According to the present invention, the improvements are applied to a conventional bag 1 which is made of a washable textile material permeable to air but not to dust, and which has, in conventional manner, an end opening 2 to be fitted on the vacuum cleaner; the bag is provided with a laminar disk 3 with characteristics of flexibility and adaptability, one face of which is occupied by the elements 4 of a hook-and-loop fastening so as to be able to receive a second annular disk 5 which has dimensions substantially corresponding to those of the disk 3, and which has, on its face facing the disk 3, a covering 6 of the complementary element of the hook-and-loop fastening which corresponds to the said disk 3. The opening 7 in the disk 5 coincides with the opening 2 in the bag and in the disk 3.

The disk 5 can be fitted in a manner such that it can be mounted and removed easily owing to the provision of the fastening elements constituted by the hooks and projections and, given the characteristics of flexibility and adaptability of the disk 3, the bag as a whole is easily washable.

The front face 12 of the disk 5 is provided with a coating of adhesive on which a third disk, indicated 8 and having the same dimensions as the disks 3 and 5, is fixed; said third disk can be detached easily from the disk 5 which can be fixed to a piece of cardboard 13 or the like, possibly cut from another, already-used bag of the desired type, enabling the bag of the invention to be used in any desired vacuum-cleaner.

The bag has at its other end, remote from the above-mentioned mouth, a slide fastener 9 which enables the bag to be opened and closed quickly and repeatedly. The use of the bag incorporating the present improvements can be seen in FIG. 5 which shows the bag 1 carrying the disk 3, which is attached to the textile body of the bag 1 by a permanent layer of adhesive or the like and is arranged to be attached, by means of the covering 4, to the covering 6 of the disk 5 which in turn will have been connected, for example, by means of adhesive, to the receiving plate 10 of the casing 11 of the vacuum cleaner of the desired type.

The arrangement described enables the bag to be fitted on and removed from the members of the vacuum-cleaner easily and, moreover, enables the bag to be washed easily and reused repeatedly.

Although the preferred embodiment of the bag is made of a washable synthetic material, likewise it could also be made of a non-reclaimable material, of fabric, cellulose material, etc.

1. Improvements in vacuum-cleaner bags of the type which comprise a textile bag element which is permeable to air but not to dust, with a mouth in which the fixed portion of the vacuum-cleaner can be coupled by means of an adhesive connection, the improvements being characterized by the arrangement of an element in the form of a flexible and adaptable flat disk fixed permanently in the mouth of the bag, the element having a hook-and-loop fastening element on its outer face, a second element also being provided in the form of a flat disk which is of similar shape to the first, is provided with a complementary hook-and-loop fastening element on its opposite face, and can be fitted removably on the disk fixed in the bag, the second element in turn having, on its outer face, an adhesive region to which a removable protective disk is applied, the bag also having, at its opposite end, a slide fastening permitting easy fitting, removal, emptying and washing thereof.
